(19) United States
(12) Patent Application Publication
(10) Pub. No.: US 2025/0214073 A1
(43) Pub. Date: Jul. 3, 2025

(54) METHOD FOR MANUFACTURING HIGH-EFFICIENCY DENITRATION CATALYSTS, METHOD FOR MODIFYING THE SURFACE OF PTFE FIBERS BY MIXING SOLID PARTICLES, AND METHOD FOR MANUFACTURING PTFE CATALYST FILTER

(71) Applicant: Micro-one co.,ltd., Cheonan-si (KR)

(72) Inventors: Ji Han SIM, Cheonan-si (KR); Heok Soo JEON, Cheonan-si (KR); CARG RO LEE, Cheonan-si (KR); SEO YOUNG LEE, Cheonan-si (KR); Junghwan KIM, Cheonan-si (KR); Seongshin CHOI, Cheonan-si (KR)

(21) Appl. No.: 18/981,593

(22) Filed: Dec. 15, 2024

(30) Foreign Application Priority Data
Dec. 29, 2023 (KR) 10-2023-0196134

(51) Int. Cl. B01J 35/59; B01D 53/86; B01J 23/22; B01J 29/00; B01J 37/02

(52) U.S. Cl. CPC B01J 35/59; B01D 53/8628; B01J 23/22; B01J 29/00; B01J 37/0201; B01D 2255/20723; B01D 2255/915; B01D 2257/404

(57) ABSTRACT

Disclosed are a method of manufacturing a high-efficiency denitrification catalyst by adjusting components constituting a denitrification catalyst and a ratio between respective components, a method of modifying the surface of PTFE fibers by extruding, rolling, stretching and slitting a PTFE billet manufactured using mixed solid particles, and a method of producing a PTFE catalyst filter by the methods.

### BACKGROUND OF THE INVENTION

### 1. Field of the Invention

The present invention relates to a method of manufacturing a denitrification catalyst, and more particularly a method of manufacturing a more efficient denitrification catalyst by adjusting components constituting a denitrification catalyst and a ratio between the respective components.

In addition, the present invention relates to a method of producing a powder for manufacturing PTFE fibers by mixing a denitrification catalyst with a PTFE powder in an appropriate amount.

In addition, the present invention relates to a method of modifying the surface of PTFE fiber, and more particularly a method for modifying the surface of PTFE fiber by applying mixed denitrification catalyst solid particles so as to impart denitrification performance to the PTFE fiber.

In addition, the present invention relates to a method of manufacturing a PTFE catalyst filter, and more particularly a method of manufacturing a PTFE catalyst filter using PTFE fibers whose surface is modified using a catalyst.

Further, the present invention discloses a PTFE membrane lamination method that can reduce the desorption of catalyst particles from PTFE catalyst filter media during a lamination process and, accordingly, improve DeNOx efficiency.

In addition, a production system for a PTFE membrane catalyst filter that can increase productivity through efficient drying when coating a catalyst on a PTFE nonwoven fabric is disclosed.

### 2. Description of the Related Art

There is a trend of strengthening laws and regulations worldwide to minimize air pollution. Accordingly, each country is showing great interest in developing various dust collection facilities and high-performance materials to reduce emissions of dust and various combustion products contained in exhaust gas.

In particular, nitrogen oxides (NOx) are contained in exhaust gases emitted from essential equipment such as power plants, automobiles, and ships, and since they directly affect air pollution, controlling NOx emissions is becoming an important issue.

The filter industry is growing rapidly to prevent air pollution, and in particular, the competitiveness of bag filter products manufactured by combining PTFE membranes with various non-woven fabrics is increasing. Recently, a PTFE membrane catalyst filter product that can remove combustion products in exhaust gas together with the PTFE membrane filter is being developed.

Conventionally, catalytic reduction of nitrogen oxides has been used to reduce NOx in exhaust gas. In general, a catalytic reduction process is also called a selective catalytic reduction process, diminishingly SCR (Selective Catalytic Reduction) process, which uses ammonia (NH₃) or an ammonia precursor present in exhaust gas as a reducing agent.

The NOx treatment efficiency varies depending on a catalyst used in the SCR process. Vanadium oxides are usefully used in this SCR process. Among them, vanadium oxide catalysts applied to catalyst filters are manufactured by coating a catalyst on a filter surface.

However, PTFE fibers are hydrophobic fluorine polymer fibers, so there is a problem that an organic solvent should be used for catalyst coating, and there is a problem that the coated catalyst is desorbed during a dedusting process.

Therefore, research is being conducted on a method of manufacturing a high-efficiency denitrification catalyst applicable to PTFE membrane filters and a method of manufacturing a catalyst filter using such a denitrification catalyst.

### RELATED ART DOCUMENT

### Patent Document

(Patent Document 1) Korean Patent No. 10-2478940

### SUMMARY OF THE INVENTION

Therefore, the present invention has been made in view of the above problems, and it is one object of the present invention to provide a method of manufacturing a more efficient denitrification catalyst by adjusting the components constituting a denitrification catalyst and a ratio between the respective components.

It is another object of the present invention to provide a method of modifying the surface of fibers by applying mixed denitrification catalyst solid particles to impart the denitrification performance to the PTFE fiber.

It is still another object of the present invention to provide a method of manufacturing a PTFE catalyst filter using PTFE fibers whose surface is modified using a catalyst.

It is still another object of the present invention to provide a PTFE membrane lamination method of reducing the desorption of catalyst particles during a catalyst filter manufacturing process.

It is yet another object of the present invention to provide a PTFE membrane catalyst filter production system that can enhance the performance of the filter and improve productivity through efficient drying during catalyst coating.

In accordance with an aspect of the present invention, the above and other objects can be accomplished by the provision of a method for modifying a surface of PTFE fiber by mixing with solid particles, the method comprising: mixing PTFE powder and De-NOx catalyst in a mixer and compressing it to produce a PTFE billet; extruding the produced PTFE billet to generate a PTFE rod; rolling the PTFE rod using a heated roller to produce a PTFE film; and stretching the PTFE film in a longitudinal direction, and then producing PTFE fibers through a slitting process, wherein catalyst particles present inside the PTFE film are exposed to a fiber surface through the stretching and the slitting process.

According to an embodiment of the present invention, the De-NOx catalyst may be manufactured by supporting greater than 0 wt % and less than 5 wt % of V₂O₅ and greater than 5 wt % and less than 10 wt % of a promoter on 85 wt % or more and less than 95 wt % of a zeolite support based on a total weight of the catalyst.

According to an embodiment of the present invention, the De-NOx catalyst may be added in an amount of 5 wt % to 8 wt % based on a total weight of the powder.

According to an embodiment of the present invention, the promoter may be selected from the group consisting of copper (Cu), manganese (Mn), tungsten (W), boron (B), aluminum (Al), bismuth (Bi), silicon (Si), tin (Sn), lead (Pb), antimony (Sb), chromium (Cr), iron (Fe), cobalt (Co), nickel (Ni), zinc (Zn), gallium (Ga), cerium (Ce), yttrium (Y), niobium (Nb) and molybdenum (Mo).

According to an embodiment of the present invention, the supported zeolite may be manufactured in a powder form by drying at a temperature of 140° C. or higher and lower than 160° C. for 10 hours to 13 hours and heat-treating in a muffle furnace at a temperature of 350° C. or higher and lower than 450° C. for a time of 3 hours or more and less than 5 hours, and then ground by a ball mill.

In accordance with another aspect of the present invention, there is provided a method of manufacturing PTFE fibers, the method comprising: mixing a De-NOx catalyst, manufactured by using PTFE powder and zeolite as a support and using vanadium and a promoter adjusted at a predetermined ratio, in a mixer and compressing it to produce a PTFE billet; extruding the produced PTFE billet to generate a PTFE rod; rolling the PTFE rod using a heated roller to produce a PTFE film; and stretching the PTFE film in a longitudinal direction, and then manufacturing it in a fiber shape through a slitting process.

According to an embodiment of the present invention, the De-NOx catalyst may be manufactured by supporting greater than 0 wt % and less than 5 wt % of V₂O₅ and greater than 5 wt % and less than 10 wt % of a promoter on 85 wt % or more and less than 95 wt % of a zeolite support based on a total weight of the catalyst.

According to an embodiment of the present invention, the De-NOx catalyst may be added in an amount of 5 wt % to 8 wt % based on a total weight of the powder.

According to an embodiment of the present invention, the promoter may be selected from the group consisting of copper (Cu), manganese (Mn), tungsten (W), boron (B), aluminum (Al), bismuth (Bi), silicon (Si), tin (Sn), lead (Pb), antimony (Sb), chromium (Cr), iron (Fe), cobalt (Co), nickel (Ni), zinc (Zn), gallium (Ga), cerium (Ce), yttrium (Y), niobium (Nb) and molybdenum (Mo).

According to an embodiment of the present invention, the supported zeolite may be manufactured in a powder form by drying at a temperature of 140° C. or higher and lower than 160° C. for 10 hours to 13 hours and heat-treating in a muffle furnace at a temperature of 350° C. or higher and lower than 450° C. for a time of 3 hours or more and less than 5 hours, and then ground by a ball mill.

In accordance with yet another aspect of the present invention, there are provided PTFE fibers manufactured by the PTFE fiber manufacturing method, a PTFE nonwoven fabric manufactured using the PTFE fibers, and a PTFE catalyst filter produced by laminating the PTFE nonwoven fabric to a PTFE membrane filter.

### Advantageous Effects

According to the present invention, a more efficient denitrification catalyst can be manufactured by adjusting the components constituting the denitrification catalyst and a ratio between the respective components.

In addition, the efficiency of a filter can be improved by manufacturing a catalyst exhibiting relatively stable performance over a wide temperature range according to the present invention.

In addition, by adding a catalyst during the PTFE fiber manufacturing process according to the present invention, the catalyst can be uniformly added to the PTFE fiber, so the desorption problem of the catalyst during a dedusting process can be solved.

In addition, a catalyst powder for manufacturing PTFE fibers with less efficiency reduction compared to the denitrification efficacy of the catalyst powder itself can be produced by optimizing the ratio of PTFE powder and catalyst powder.

In addition, by applying mixed denitrification catalyst solid particles to impart denitrification performance to PTFE fibers, the surface of PTFE fiber can be modified, and by using this, a PTFE catalyst filter in which a catalyst is uniformly added to PTFE fibers can be produced.

In addition, it is possible to improve the DeNOx efficiency of a catalyst filter by reducing the desorption of catalyst particles in a lamination process.

Further, when producing a catalyst filter by coating a denitrification catalyst on a PTFE nonwoven fabric according to one embodiment of the present invention, the productivity of the filter can be improved by efficiently drying it.

### BRIEF DESCRIPTION OF THE DRAWINGS

FIG. 1 illustrates a photograph of denitrification catalyst samples in which the mixing ratios of V₂O₅ to a promoter are different.

FIG. 2 illustrates XRD pattern analysis graphs of denitrification catalyst samples.

FIG. 3 illustrates an XPS analysis graph for the promoter 2p of each denitrification catalyst sample.

FIG. 4 illustrates an XPS analysis graph for the V2p orbital binding energy of each denitrification catalyst sample.

FIG. 5 illustrates acid point analysis result graphs for denitrification catalyst samples by NH₃-TPD experiments.

FIG. 6 illustrates NOx adsorption characteristic analysis result graphs for denitrification catalyst samples by NO-TPD experiment.

FIG. 7 illustrates graphs of the NO conversion rates of denitrification catalyst samples in an NH₃-SCR reaction.

FIG. 8 illustrates a set of graphs comparing the N₂O production amounts of denitrification catalyst samples dependent upon temperature in an NH₃-SCR reaction.

FIG. 9 illustrates a set of graphs comparing the N₂ selectivity of denitrification catalyst samples in an NH₃-SCR reaction.

FIG. 10 illustrates a set of graphs comparing NO concentration changes in denitrification catalyst samples due to SO₂ inflow.

FIG. 11 illustrates a set of graphs including the NO conversion rates of denitrification catalyst samples due to SO₂ inflow.

FIG. 12 illustrates a set of graphs comparing the moisture influences of denitrification catalyst samples in a H₃-SCR reaction.

FIG. 13 is a drawing illustrating the process of manufacturing PTFE catalyst filter fibers using PTFE powder and catalyst powder.

FIG. 14 illustrates photographs of PTFE catalyst filter fibers manufactured to have different catalyst contents.

FIG. 15A illustrates the SEM image of a PTFE catalyst filter when the content of the catalyst is 5 wt %.

FIG. 15B illustrates the SEM image of a PTFE catalyst filter when the content of the catalyst is 8 wt %.

FIG. 15C illustrates the SEM image of a PTFE catalyst filter when the content of the catalyst is 10 wt %.

FIG. 16 is a conceptual diagram explaining the surface modification mechanism in a manufacturing process of PTFE catalyst filter fibers.

FIG. 17 illustrates the cross-sectional views of PTFE catalyst filter fibers having different catalyst contents, observed by the EDX mapping technique.

FIG. 18 illustrates a set of graphs for comparing the activity of PTFE fibers dependent upon the addition amount of a catalyst in an NH₃-SCR reaction.

FIG. 19 illustrates a graph comparing the actual catalyst contents of PTFE fibers by TG analysis.

FIG. 20 illustrates a set of graphs comparing the NO conversion rates of a powder catalyst and a PTFE catalyst fiber in an NH₃-SCR reaction.

### DETAILED DESCRIPTION OF THE INVENTION

Hereinafter, the present invention is described in more detail with reference to the accompanying drawings. In this specification, the same or similar reference numbers are given to the same or similar configurations also in different embodiments, and the description thereof is replaced with the first description. In this specification, the singular expressions include the plural expressions unless the context clearly indicates otherwise.

In addition, when explaining with reference to the accompanying drawings, the same components are given the same reference numbers regardless of the drawing numbers, and redundant descriptions thereof are omitted. Meanwhile, in the following description of the present invention, a detailed description of known technologies incorporated herein will be omitted when it may make the subject matter of the present invention unclear.

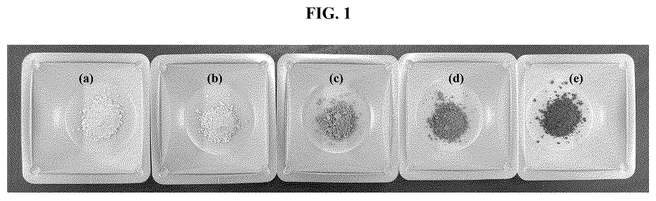

FIG. 1 illustrates a photograph of denitrification catalyst samples in which the mixing ratios of V₂O₅ to a promoter are different.

In the present invention, a method of manufacturing a denitrification catalyst by a content ratio of a vanadium-based Selective Catalytic Reduction (SCR) catalyst to a promoter and supporting it on the surface of a zeolite support is disclosed.

In an embodiment of the present invention, the vanadium-based SCR catalyst may be preferably vanadium pentoxide (V₂O₅).

According to a preferred embodiment of the present invention, the promoter may be copper (Cu), manganese (Mn), tungsten (W), or the like. However, the promoter is not limited to the elements and may include metal elements such as boron (B), aluminum (Al), bismuth (Bi), silicon (Si), tin (Sn), lead (Pb), antimony (Sb), chromium (Cr), iron (Fe), cobalt (Co), nickel (Ni), zinc (Zn), gallium (Ga), cerium (Ce), yttrium (Y), niobium (Nb) and molybdenum (Mo).

According to a preferred embodiment of the present invention, zeolite may be used as a support. Zeolite is a group of minerals with a fine porous structure, and these minerals have a crystalline framework composed of aluminum, silicon, oxygen, etc.

The amount of active material supported on the surface of the zeolite support was fixed to 10 wt %.

Hereinafter, the examples of the present invention are described by dividing them into Sample (a), Sample (b), Sample (c), Sample (d) and Sample (e) according to a content ratio of V₂O₅ to the promoter.

The content ratio of V₂O₅ to the promoter in Sample (a) was set to 100:0, the content ratio of V₂O₅ to the promoter in Sample (b) was set to 75:25, the content ratio of V₂O₅ to the promoter in Sample (c) was set to 50:50, the content ratio of V₂O₅ to the promoter in Sample (d) was set to 25:75, and the content ratio of V₂O₅ to the promoter in Sample (e) was set to 0:100.

The sample ratios are optimal experimental ratios, but the present invention may include a slightly wider range in embodiments. For example, Sample (b) may include a range of 70:30 to 65:35, Sample (c) may include a range of 45:55 to 55:45, and Sample (d) may include a range of 20:80 to 30:70. These ranges may also be applied to the examples described below. Even if only an optimal ratio is specifically mentioned in each example, it should be understood that this is for the convenience of explanation and includes the ranges described above. For example, even if it is mentioned that Sample (d) with a ratio of 25:75 was used, the ratio of the sample (d) can be understood to include a range of 20:80 to 30:70.

Hereinafter, for the convenience of explanation, the vanadium-based composite SCR catalyst of the present invention using zeolite as a support is referred to as “V₂O₅-promoter/zeolite catalyst.”

As shown in FIG. 1, it can be confirmed that the color becomes yellow as the vanadium content increases, and the color becomes dark gray as the content of the promoter increases.

In the manufacturing process, zeolite powder was used as a support, and vanadium hexahydrate was used as a precursor of active materials, V₂O₅ and a promoter.

A precursor material was manufactured as an aqueous solution and then mixed. The precursor material in an aqueous solution state and zeolite powder were mixed in a round bottom flask, and then moisture was slowly removed in a rotary vacuum evaporator to support vanadium and a promoter on the zeolite surface.

The zeolite-based catalyst supported with the precursor material was dried using a dryer at 150° C. for 12 h and heat-treated in a muffle furnace at 400° C. for 4 h. The heat-treated catalyst was subjected to a comparison experiment of catalytic activity by NH₃-SCR reaction in powder form.

The catalyst was finely ground using a ball mill, and then mixed with PTFE powder to be used to manufacture a PTFE catalyst filter.

### <Analysis of Properties and Surface Characteristics of Catalyst>

A denitrification catalyst was made by supporting vanadium and a promoter on the surface of hydrophobic zeolite, and the surface area, pore volume, and pore size of the catalyst were measured using a nitrogen adsorption method (Micromeritics, 3-Flex).

The crystal structure of a catalyst active material supported on a zeolite support was analyzed by X-Ray Diffractometer (XRD, DIAOME, MOD for bulk (powder)). The oxidation state of an active material supported on a trace of zeolite support, which is difficult to analyze by XRD, was confirmed by XPS analysis.

In addition, to observe the adsorption and desorption behaviors of NH₃ and NO of the manufactured catalyst, the NH₃ and NOx TPD experiment (BEL Japanc Inc., BELCAT II) was performed.

The NH₃-TPD experiment was performed as follows:

The TPD experiment was conducted by filling a catalyst into a reactor for the TPD experiment, and then purging it by flowing argon gas at 300° C. for 2 h, and then adsorbing an adsorption gas onto the catalyst by flowing about 1 vol % of NO gas or 5 vol % of NH₃ gas of an argon balance at room temperature, and then measuring the change in a desorption amount while increasing the temperature from room temperature to 900° C. at a rate of 10° C./min.

Meanwhile, to confirm the support degree of the catalyst distributed on PTFE fibers containing the catalyst, it was observed using a scanning electron microscope (FE-SEM/EDS(3), HITACHI, Ltd, S-4800), and the distribution of V, Si, Al, etc. on the surface of the PTFE fibers and inside thereof was observed using the EDX mapping technique.

### <Analysis of Surface Area and Pore Characteristics by N₂-Adsorption Method>

The surface area, pore volume, and pore size of each of five zeolite-supported catalysts, in which the contents of vanadium and promoter contents were controlled, manufactured in the present invention were measured by the nitrogen adsorption method.

As measurement results, the catalysts were confirmed to have a broad surface area of about 681 to 715 m²/g, as shown in Table 1 below.

When only vanadium or a promoter was supported (Sample (a) or (e)), a relatively low surface area was observed. The pore volume and the pore size were confirmed to be about 0.19 to 0.22 cm³/g and 4.6 to 5.2 nm.

TABLE 1

| | Surface area, | Total pore volume, | Mean pore size, |
|---|---|---|---|
| Catalysts | m²/g | cm³/g | nm |
| Sample (a) | 681.1 | 0.22 | 5.2 |
| Sample (b) | 715.2 | 0.23 | 4.9 |
| Sample (c) | 711.0 | 0.19 | 5.2 |
| Sample (d) | 705.1 | 0.19 | 4.9 |
| Sample (e) | 681.2 | 0.19 | 4.6 |

### <Crystal Structure Analysis of Catalysts by XRD>

To verify the crystal structures of the vanadium and promoter catalyst supported on the powder catalyst, XRD analysis was performed.

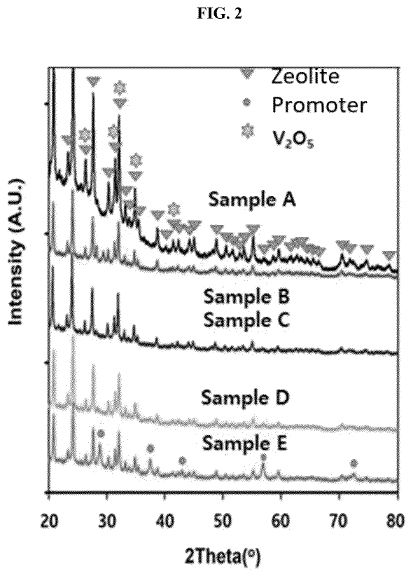

FIG. 2 illustrates XRD pattern analysis graphs of denitrification catalyst samples.

Referring to FIG. 2, the XRD diffraction pattern showed a strong diffraction pattern for the zeolite used as a support, and very weak peak intensities for V₂O₅ and the promoter. Nevertheless, the characteristic peaks of the promoter were confirmed at 2-theta 28°, 38°, 44°, 56°, and 59° of the XRD patterns of the promoter/zeolite catalyst.

However, no peak capable of specifying vanadium was identified. This is because the catalyst active material, V₂O₅, and the promoter are supported on the wide surface of zeolite, and thus, no crystalline peaks appear due to high dispersion.

Since the crystallinity of vanadium could not be confirmed by XRD analysis, the crystal structure could not be specified, and since the oxidation state change of vanadium and the promoter into a composite oxide could not be observed, the oxidation state of the metal oxide was investigated by XPS analysis.

<Oxidation State Analysis of V₂O₅ and Promoter by XPS>

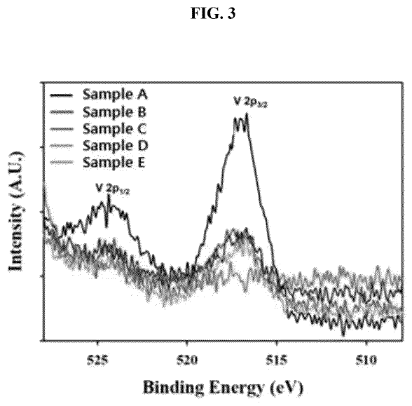

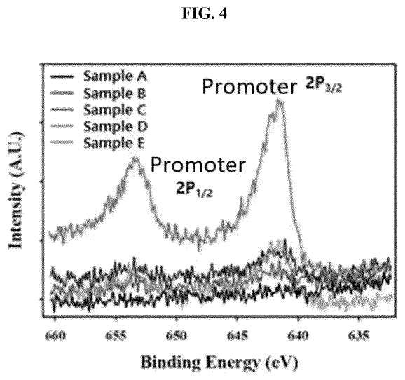

FIG. 3 illustrates an XPS analysis graph for the promoter 2p of each denitrification catalyst sample, and FIG. 4 illustrates an XPS analysis graph for the V2p orbital binding energy of each denitrification catalyst sample.

XPS analysis was performed to investigate the V₂O₅-promoter composite oxide formation of catalysts in which vanadium and the promoter are mixed.

Referring to FIG. 3, it is considered that the composite oxide was not formed, as can be confirmed from the XPS results of V and the promoter.

Referring to FIGS. 3 and 4, binding energy values of typical V₂O₅ and promoter are observed.

Referring to the drawings, a peak appears at 516.8 eV which is the binding energy of V2p_{3/2} in V₂O₅, and a peak of V2p_{1/2} can be confirmed at 524.3 eV. Through this, it can be confirmed that no shift in binding energy is observed.

Referring to FIG. 4, the binding energy of promoter2p_{3/2} is observed at 642.3, and the binding energy of promoter2p is observed at 654.1 eV. These can be said to be an XPS spectrum that appears in a typical promoter.

However, considering that the binding energy of promoter2p is broadly distributed from 641.2 to 642.3 eV, it is considered to exist together with a promoter.

In the XPS spectrum, a small peak at 529 eV for O1s binding energy can be seen as the binding energy appearing in the oxygen bond of the promoter, and the peak appearing at 530 eV is characterized as the spectrum of O1s corresponding to V-O of V₂O₅.

<Scatter Plot Analysis by NH₃-TPD>

In the present invention, NH₃-TPD experiments were performed to investigate the NH₃ adsorption characteristics of the five catalysts manufactured.

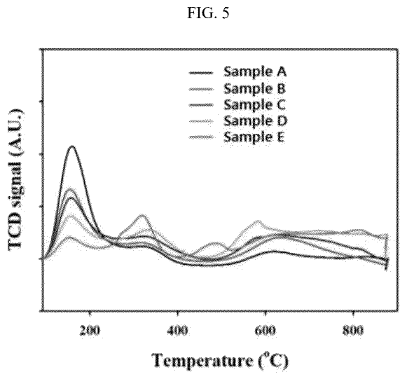

FIG. 5 illustrates acid point analysis result graphs for denitrification catalyst samples by NH₃-TPD experiments.

As shown in FIG. 5, it can be seen that the five catalyst samples show significantly different NH₃ desorption behaviors.

As comparison results of NH₃ desorption behaviors in a temperature range of 100 to 250° C., it was observed that the desorption amount of NH₃ increases with increasing V₂O₅ content. On the other hand, the desorption amount decreases as the content of the promoter increases.

Next, it can be confirmed that, in a temperature range of 250 to 500° C., the desorption amount of NH₃ increases as the content of the promoter increases. In a temperature range of 500 to 900° C., it can be confirmed that the desorption amount of NH₃ increases as the content of the promoter increases.

Based on these results, it can be confirmed that most NH₃ is desorbed in a low-temperature region of 250° C. or less when the vanadium content is high.

However, it can be confirmed that, as the content of the promoter increases, the desorption of NH₃ decreases below 250° C. or lower and increases above 250° C.

Accordingly, it can be determined that, in the low-temperature NH₃-SCR reaction below 250° C., the adsorption amount of a reducing agent, NH₃, increases as the content of the promoter increases, so that the denitrification performance is improved.

At high temperatures, ammonia desorption has a high adsorption intensity, which may be because the catalyst has a relatively higher acid point. When the adsorption intensity of a reactant is strong, the reaction on the catalyst surface is more favorable, so it can be considered that the promoter affects the reaction rate of the catalyst.

In FIG. 5, the NH₃ desorption peak in a range of 100 to 200° C. corresponds to a weak Brønsted acid point, and the desorption peak in a range of 300 to 400° C. corresponds to the Lewis acid point.

According to other studies (Wang, etc.), when the Lewis acid point is high on the Ce/TiO₂ catalyst, the denitrification performance is high, and when alkali metals (Na, K) are adsorbed, the desorption peak corresponding to the Lewis acid point becomes weak, and the denitrification performance deteriorates.

In addition, according to other studies (Liu, etc.), the desorption peak due to NH₄⁺ and coordination NH₃, bound to the strong Brønsted acid point and Lewis acid point above 200° C., on FeTiOx and TiO₂ catalysts affects the high denitrification performance of the catalyst. According to still other studies (Li, etc.), the promoter/TiO₂ catalyst formed by adding Nb to the promoter/TiO₂ catalyst showed a high NH₄ desorption peak above 300° C. in the NH₃-TPD experiment, and this catalyst had high denitrification performance.

In the vanadium-based composite SCR catalysts of the present invention using zeolite as a support, it was confirmed that the adsorption of coordinated NH₃ bound to the Lewis acid point tended to increase as the content of the promoter increases, and the catalyst with an increasing Lewis acid point had a relatively high denitrification performance.

<NOx Adsorption Characteristic Analysis of V₂O₅-Promoter/Zeolite Catalysts by NOx-TPD>

To observe the adsorption/desorption behavior of NO which is a reactant of NH₃-SCR reaction, the five catalysts were subjected to NOx-TPD experiment.

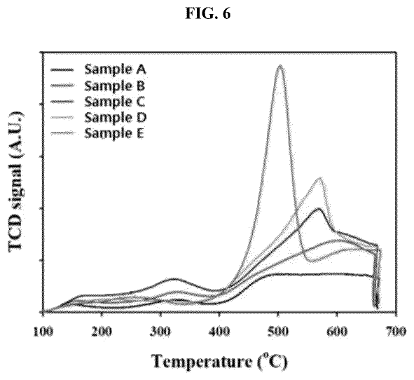

FIG. 6 illustrates a set of graphs of NOx adsorption characteristic analysis results of denitrification catalyst samples by NO-TPD experiment.

Referring to FIG. 6, it can be confirmed that the desorption behavior of NO shows a significant difference depending upon the composition ratio of the catalyst active material.

In the case of NO, a large amount of NO was desorbed in the high-temperature range, unlike NH₃.

There was no significant difference in the low-temperature range, but in the range of 100 to 400° C., the desorption amount was higher when vanadium and the promoter were supported together or only the promoter was supported than when only vanadium was supported.

In particular, the desorption amount was highest when the promoter and vanadium were supported in a ratio of 5:5 (Sample (c)). Meanwhile, most of the adsorbed NO was desorbed at temperatures above 400° C., and the desorption amount was higher when the content of the promoter was higher.

These results imply that the NO adsorption amount of the promoter is relatively high, and it may be determined that both V₂O₅ and the promoter have strong adsorption capacity for NO.

However, the relative NO adsorption amount was confirmed to be greater for the promoter than for vanadium, and the adsorption intensity was confirmed to be relatively lower as the content of the promoter increased. This can be considered to be similar to the trend that the catalyst, to which the promoter was added, showed the increased desorption amount in the low-temperature range.

In all of the five examples, the strong adsorption capacity for NO means that the adsorption intensity of NOx does not determine the catalyst reaction rate, but rather the adsorption intensity and adsorption amount of NH₃ determine the overall reaction rate.

### <Activity Evaluation for Denitrification Catalyst for NH₃-SCR>

Activity Evaluation Method of V₂O₅-Promoter/Zeolite Catalyst

The activity of the manufactured denitrification catalyst was tested in a fixed-bed catalyst reaction system. After filling a tubular reactor with the catalyst, nitrogen oxide was introduced thereinto, and ammonia was supplied thereto to cause the NH₃-SCR reaction.

Nitrogen oxide and nitrogen and ammonia gases were connected to the front end of the reactor, and air was supplied thereto using an air compressor.

To investigate the sulfur tolerance of the catalyst, about 20 ppmv of SO₂ was mixed in a reactant gas, and, to investigate the effect of moisture, approximately 2, 5, 8, and 10 vol % of moisture was supplied.

A mass flow controller (MFC, maker) was used to mix the reaction gases, and a gas mixer was installed just before being supplied to the reactor to mix simulated gases.

A gas supply line was heated using a line heater to preheat the incoming gas, and a thermometer was inserted into a catalyst-charged bed in the reactor to measure the temperature of the catalyst bed.

A pressure gauge was installed on the top of the reactor to observe a pressure change inside the reactor due to the catalyst-charged bed.

A reactor outlet was directly connected to a gas analyzer, and the nitrogen oxide concentration at the reactor outlet was measured before and after an ammonia gas was introduced.

The initial concentration of NOx before the reaction was measured by flowing the reaction gases through a bypass line without passing through the catalyst layer.

The reaction temperature was controlled in a range of 150 to 230° C. and the catalyst activity was measured.

The loading amount of the powder catalyst was set to 0.5 to 0.7 g, and the loading amount of the fiber catalyst was set to 5 to 7 g. When set in this way, the catalyst-based space velocity of the powder catalyst and the fiber catalyst was confirmed to be about 260,000 ml/g/h.

The NOx conversion rate (Mathematical Formula 1) and N₂ selectivity (Mathematical Formula 2) by H₃-SCR reaction were calculated by the following formulas:

$${X}_{{NO}_{x}} ( \% ) = \frac{{C}_{{NO}_{x} - i} - {C}_{{NO}_{x} - output}}{{C}_{{NO}_{x} - i}} \times 100 \qquad [ Mathematical Formula 1 ]$$

$${S}_{{N}_{2}} ( \% ) = 1 - \frac{2 \times {C}_{{N}_{2} O - output}}{\begin{matrix}{C}_{{NO}_{x} - i} + {C}_{{NH}_{3} - i} - \\ {C}_{{NO}_{x} - output} - {C}_{{NH}_{3} - output}\end{matrix}} \times 100 \qquad [ Mathematical Formula 2 ]$$

where X_{NOx} denotes NOₓ conversion rate, S_{N2} denotes N₂ selectivity, C_{NOx-i} denotes the concentration of NOx flowing into the reactor, C_{NOx-output} denotes the concentration of NOx flowing out of the reactor, CNH₃₋ᵢ denotes the concentration of NH₃ flowing into the reactor, and CNH₃₋ₒᵤₜₚᵤₜ denotes the concentration of NH₃ flowing out of the reactor.

Evaluation of Activity of V₂O₅-Promoter/Zeolite Catalyst in NH₃-SCR Reaction

To compare the NH₃-SCR reaction activity of the powder catalysts, denitrification performance experiments were performed for the examples while changing the reaction temperature.

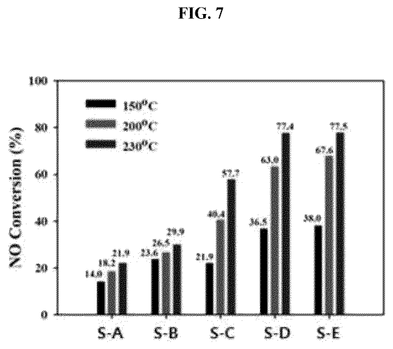

FIG. 7 illustrates graphs of the NO conversion rates of denitrification catalyst samples in an NH₃-SCR reaction.

Referring to FIG. 7, the NOx conversion rate tended to increase with increasing reaction temperature, and the NOx conversion rate also showed a significant difference depending upon the composition of the catalyst at each reaction temperature.

As shown in the drawings, the catalyst of Sample (a) showed NOx conversion rates of 14%, 18.2% and 21.0% at 150° C., 200° C. and 230° C., respectively.

It can be confirmed that the catalyst of Sample (b) shows NOx conversion rates of 23.6%, 26.5% and 29.9% at 150° C., 200° C. and 230° C., respectively, which are higher than the case that only V₂O₅ is a support.

It can be confirmed that the catalyst of Sample (c) shows higher conversion rates under the same temperature conditions and, in particular, shows a rapidly increased NOx conversion rate above 200° C.

The catalyst of Sample (d) and the catalyst of Sample (e) showed similar NOx conversion rates under the same temperature conditions. It can be confirmed that both the catalysts show high NOx conversion rates comparable to the catalysts of Samples (a) and (b) having a low promoter content.

It can be confirmed that the catalysts of Samples (d) and (e) show a NOx conversion rate of about 77% at a reaction temperature of 230° C., and have a high NOx conversion rate of about 38% even at a low temperature of about 150° C.

Meanwhile, according to the study, NO₂ is produced by the oxidation of NO, and the concentration of NO₂ at the outlet of the catalyst reactor increases as the temperature increases. In addition, N₂O is generated by the oxidation of NH₃, and the generation amount of N₂O increases as the temperature rises, and N₂O is hardly observed below 240° C. depending on the composition of the support.

In the present invention, NO₂ was not detected during the NH₃-SCR reaction of NO. It is possible that the reduction reaction of NO₂ was fast and was not measured even if NO₂ was generated due to the strong oxidizing power of the promoter.

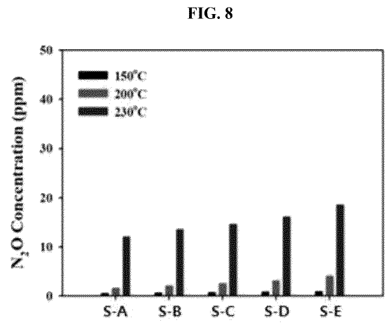

FIG. 8 illustrates a set of graphs comparing the N₂O production amounts of denitrification catalyst samples dependent upon temperature in an NH₃-SCR reaction.

Referring to FIG. 8, the N₂O measurement results of the present invention showed that the detection amount of N₂O tended to increase as the temperature increased.

From the drawing, it can be confirmed that the concentration of the concentration of N₂O starts to increase above 200° C. and rapidly increases above 230° C. All of Samples (a) to (e) showed the same tendency. In addition, it can be confirmed that the catalyst where the promoter is supported in a higher amount produces relatively more N₂O due to the oxidation of NH₃.

The experimental results showed that, as the content of the promoter increased, the catalytic activity was higher at low temperatures below 230° C. This result can be considered to occur because the NH₃ adsorption of the promoter had a higher effect than the adsorption intensity of V₂O₅.

However, when considering the production of N₂O due to the strong oxidizing power of the promoter, it is necessary to select a catalyst based on N₂ selectivity.

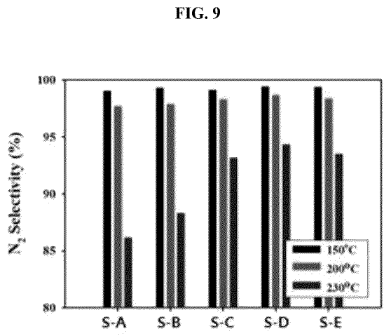

FIG. 9 illustrates a set of graphs comparing the N₂ selectivity of denitrification catalyst samples in an NH₃-SCR reaction.

From FIG. 9, it can be confirmed that the performance of the catalyst of Sample (d) is the best.

The catalytic activity of denitrification depends on the NH₃ adsorption intensity on the catalyst surface, and according to the TPD results, the NO adsorption intensity was confirmed to be high in all of the samples. Considering that the adsorption amount of NO is high in the actual reaction temperature region, it can be considered that the adsorption degree of NH₃ affects the reaction rate. Based on the results, it can be concluded that the SCR reaction on the V₂O₅-promoter/zeolite catalyst proceeds by the Langmuir-Hinselwood reaction mechanism in which NO and NH₃ are adsorbed at two activity points respectively, and then surface reactions occur. That is, the strong adsorption and high adsorption amount of NO can be considered as being due to the zeolite used as a support, and the strong adsorption of NH₃ is considered to be due to the promoter.

Activity Resistance Evaluation of V₂O₅-Promoter/Zeolite Catalyst in NH₃-SCR Reaction

In addition, to investigate the deactivation of the catalyst by SO₂, about 20 ppmv of SO₂ was introduced into the reaction gases and a change in NO conversion rate was observed.

The experiment to investigate the deactivation of the catalyst by SO₂ was performed at 200° C., and the composition of the gas flowing into the reactor was kept the same except for SO₂.

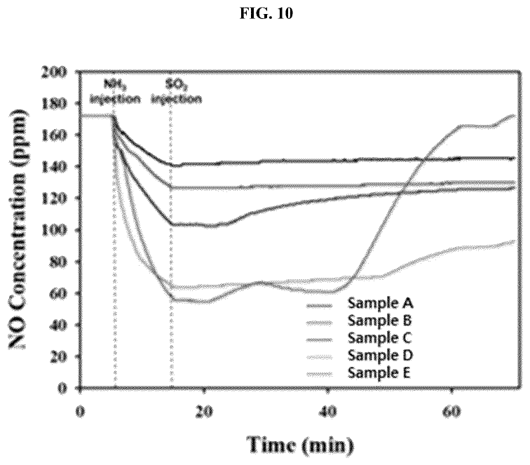

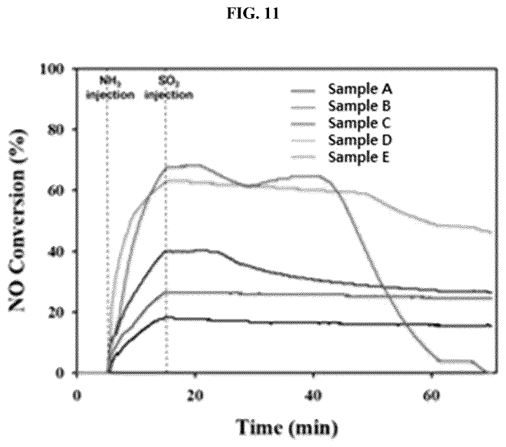

FIG. 10 illustrates a set of graphs comparing NO concentration changes in denitrification catalyst samples due to SO₂ inflow, and FIG. 11 illustrates a set of graphs including the NO conversion rates of denitrification catalyst samples due to SO₂ inflow.

From FIG. 10, it can be confirmed that the concentration of NO introduced at about 170 ppm decreases simultaneously with the supply of NH₃, and that the concentration of NO tends to increase again as SO₂ is introduced.

Referring to FIG. 11, the conversion rate increases as the content of the promoter increases. This is the same result as the catalytic activity experiment result.

As shown in the drawing, Sample (e) showed a conversion rate of about 70% before SO₂ was introduced. Next, it can be confirmed that as SO₂ is introduced, the NO conversion rate begins to decrease and seems to recover briefly in the 30 to 40 minute section, but, from 30 minutes after SO₂ inflow (40 to 50 minute section), the NO conversion rate rapidly decreases to about 5%.

It can be confirmed that, in the case of Sample (d), the NO conversion rate reaches about 63% due to the supply of NH₃, but the NO conversion rate gradually decreases due to the supply of SO₂, and the rate of decrease in the NO conversion rate increases after about 40 minutes.

In the case of Samples (a) to (c), the NO conversion rate was relatively low due to the supply of NH₃, and a change in the NO conversion rate according to SO₂ inflow was not significant.

From these experimental results, it can be confirmed that, as the content of the promoter increases, the NO conversion rate increases and the effect of deactivation due to SO₂ also increases.

When a desulfurization process is performed before the NH₃-SCR process, the promoter can have high catalytic activity because low-concentration SO₂ is intermittently introduced, but it is considered that adding some V₂O₅ will help maintain the lifespan of the catalyst against deactivation by SO₂.

Evaluation of Moisture Influence of V₂O₅-Promoter/Zeolite Catalyst in NH₃-SCR Reaction

In addition, to investigate the influence of moisture in an exhaust gas on V₂O₅-promoter/zeolite, 2, 5, 8, and 10 vol % of moisture was injected into the reaction gases.

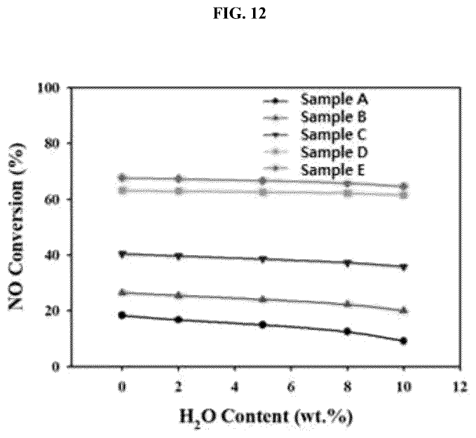

FIG. 12 illustrates a set of graphs comparing the moisture influences of denitrification catalyst samples in a H3-SCR reaction.

Referring to FIG. 12, the results of the NH₃-SCR reaction performed at 200° C. showed that the NO conversion rate decreased slightly as the moisture content increased.

As shown in the drawing, as the content of the promoter on the catalyst increases, the influence of moisture was smaller than on the catalyst with a high content of V₂O₅.

This result shows that a catalyst with relatively low catalytic activity is more greatly affected by moisture.

According to research, PTFE is added up to 10 wt % to improve the catalyst deactivation due to moisture in an exhaust gas. This can be considered an attempt to reduce the influence of moisture by adding a hydrophobic substance.

The zeolite used as a support in the present invention is a typical hydrophobic zeolite, which can play a role in reducing the catalytic activity degradation due to moisture of the V₂O₅-promoter catalyst.

### <Manufacturing of Catalyst-Added PTFE Fiber and Denitrification Performance Evaluation>

### Manufacturing of PTFE Catalyst Filter

The PTFE catalyst filter of the present invention is manufactured as a bag filter-type product after making a PTFE nonwoven fabric with PTFE fiber that is a polymer hydrophobic fiber.

According to an embodiment of the present invention, to manufacture a nonwoven fabric for bag filter production, PTFE-based fibers were first manufactured, and a catalyst for SCR was added to PTFE-based fibers by the following method. To manufacture PTFE fibers, a catalyst having a V₂O₅ ratio of more than 0 wt % and less than 5 wt %, a promoter ratio of more than 5 wt % and less than 10 wt %, and a zeolite ratio of more than 85 wt % and less than 95 wt % may be used.

The catalyst of Sample (d) examined in the previous experiment may be applied as a catalyst included in this range. That is, PTFE fibers may be manufactured using a catalyst in which 2.5 wt % V₂O₅ and 7.5 wt % promoter are supported on zeolite in PTFE powder.

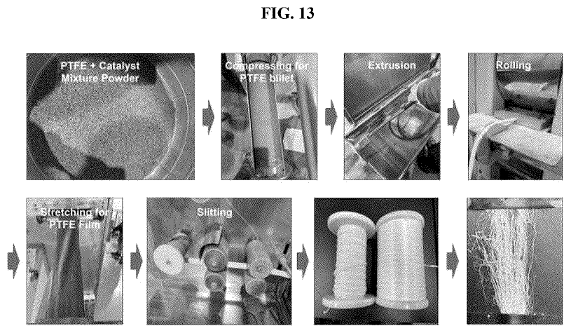

FIG. 13 is a drawing illustrating the process of manufacturing PTFE catalyst filter fibers using PTFE powder and catalyst powder.

Referring to FIG. 13, a PTFE billet was made by compressing a material mixed with PTFE and the catalyst, and a PTFE rod of a thin size was made by extruding the manufactured PTFE billet.

Next, a PTFE film is manufactured through a rolling process using a heated roller, and the film is stretched in the longitudinal direction through a stretching process and manufactured into a fiber shape through a slitting process. A nonwoven fabric is manufactured using the PTFE fibers manufactured in this manner, and a bag filter is manufactured through a lamination process.

The PTFE fiber manufacturing process is performed in the order of mixing, maturing, compression, extrusion, rolling, sintering, refining, drawing, and slitting processes.

According to a catalyst fiber manufacturing process for manufacturing the PTFE membrane catalyst filter according to the present invention, PTFE powder and a lubricant are mixed in a predetermined ratio using a mixer in the mixing process. Here, the De-NOx catalyst is added to the mixer to manufacture fibers containing the catalyst.

De-NOx catalyst particles are added to the PTFE powder and the lubricant to provide catalytic function. As the De-NOx catalyst particles are added, the ratio of raw materials in the mixture changes. Accordingly, the temperature, speed, and working time need to be changed from a general PTFE filter manufacturing process. Even if only one of temperature, speed, and working time is different, there will be a big difference in workability (continuous work), productivity (loss rate), De-NOx effect (nitrogen oxide removal function), etc.

Even if one condition changes, the performance of the catalyst filter changes, so research on the production conditions is necessary to produce good quality products efficiently.

During the manufacturing process, PTFE powder and De-NOx catalyst mixed in a powder form are put into the mixer, and then a liquid-type lubricant is sprayed.

If the ratio of the De-NOx catalyst is low, the De-NOx effect of the catalyst fiber is low, which may cause problems in commercialization. On the other hand, if the catalyst ratio is too high, breakage occurs during an elongation or slitting process, and the amount of catalyst desorption applied to a needle during slitting is large, which ultimately reduces the De-NOx effect.

When the ratio of the sprayed lubricant is low, problems may occur when forming the billet in the extrusion process. On the other hand, when the ratio of the lubricant is high, the loss rate may increase due to insufficient oil production.

The PTFE powder and the De-NOx catalyst do not melt even at very high temperatures and are physically stable, so they have properties that prevent them from chemically/physically combining with each other, so the role of the lubricant is very important in the mixing process.

In this way, the PTFE powder, the De-NOx catalyst, and the lubricant should be mixed in an appropriate ratio to reduce workability and productivity problems in the post-process.

In addition, since it is difficult to achieve uniform mixing by simply spraying the lubricant in the mixer, the method of injecting the lubricant or the operating conditions of the mixer should be set appropriately.

As the mixer rotates, centrifugal force and gravity are applied to the mixture. The mixture is evenly mixed by the centrifugal force and gravity by repeating rotation and falling. The lubricant is sprayed on the uniformly mixed mixture to create a billet with the catalyst mixed in an appropriate ratio.

If the rotation speed of the mixer is too fast, the PTFE powder will not be mixed evenly and will clump together, preventing the formation of a uniform billet. If the spray amount of the lubricant increases, the mixture will clump and not form a uniform billet.

The lubricant should be sprayed only on the powder mixture. If the lubricant is sprayed on the wall of the mixer, the powder mixture will stick to the wall of the mixer, causing loss and preventing even mixing.

As the amount of De-NOx catalyst increases, the De-NOx effect increases, so it is generally recommended to increase the catalyst content in the mixture. However, as the amount of De-NOx catalyst increases, the amount of the lubricant and the mixing time should also increase, so the amount of catalyst, the amount of lubricant, and the mixing time should be appropriately adjusted considering the dispersibility, workability, and productivity of the catalyst.

According to one embodiment of the present invention, the amount of the lubricant was set to 25 wt % or more and 30 wt % or less, and the spraying speed of the lubricant was set to 150 g/min or more and less than 250 g/min. In addition, the rotation speed of the mixer was set to 10 rpm or more and less than 15 rpm, and the mixing time was set to 30 minutes or more and less than 70 minutes.

In the present invention, the denitrification performance of the PTFE fibers manufactured through this process was evaluated.

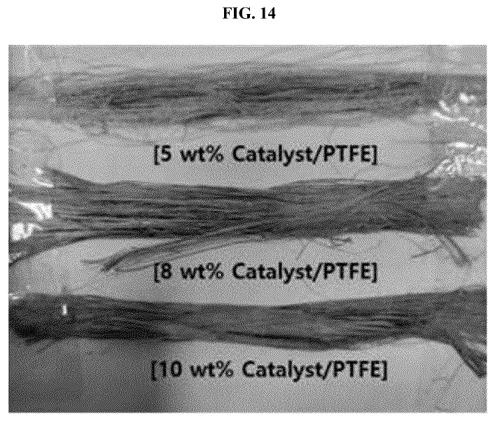

FIG. 14 illustrates photographs of PTFE catalyst filter fibers manufactured to have different catalyst contents.

Referring to FIG. 14, three types of fibers with different amounts of catalyst were used in the following experiments. As shown in the drawing, the catalyst addition amount of each fiber was adjusted to 5, 8, and 10 wt % of the total weight for the tests.

That is, the results of the experiments where the De-NOx catalyst was 5 wt %, 8 wt %, and 10 wt % of the weight of the powder for manufacturing PTFE fibers were compared.

According to the experimental results, it is preferable that the De-NOx catalyst is manufactured by supporting 0 wt % to 5 wt % of vanadium and 5 wt % to 10 wt % of the promoter on 85 wt % to 95 wt % of the zeolite support, and is manufactured in 5 wt % to 8 wt % based on the weight of the powder for manufacturing PTFE fibers.

The detailed analysis of the experiment results is reviewed in detail below.

### Surface Morphology Analysis of PTFE Catalyst Filters by SEM Analysis

To analyze the surface morphologies of PTFE catalyst filters, the catalyst of Sample (d) examined in the above experiment was used. That is, the surface morphologies of PTFE fibers produced using the catalyst in which 2.5 wt % of V₂O₅ and 7.5 wt % of the promoter based on the total weight of the catalyst were supported on the zeolite support were observed using a scanning electron microscope.

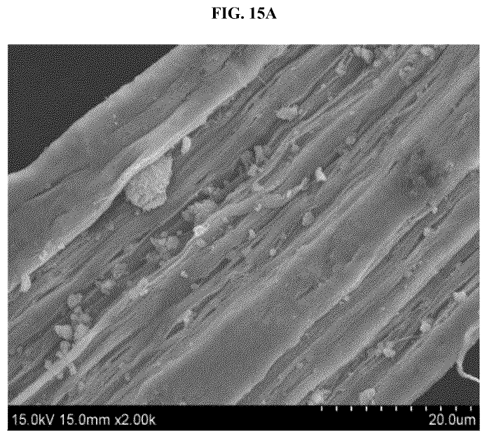

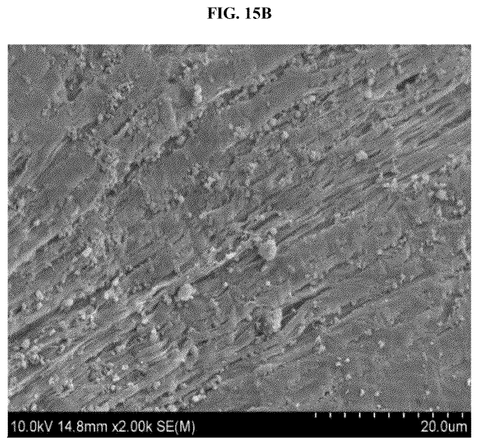

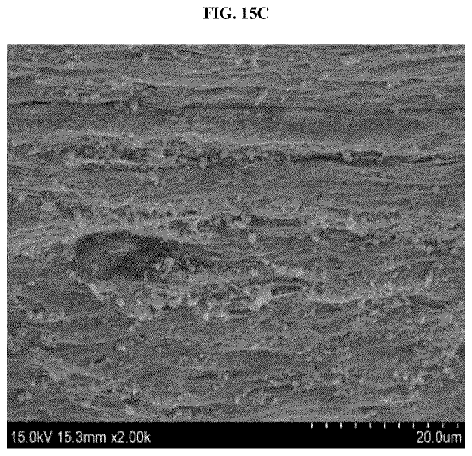

FIG. 15A illustrates the SEM image of a PTFE catalyst filter when the content of the catalyst is 5 wt %, FIG. 15B illustrates the SEM image of a PTFE catalyst filter when the content of the catalyst is 8 wt %, and FIG. 15C illustrates the SEM image of a PTFE catalyst filter when the content of the catalyst is 10 wt %.

As shown in the drawings, catalyst particles uniformly dispersed on the surface of PTFE fibers were observed.

From the drawings, in the manufacturing process of PTFE-based catalyst filters, it can be observed that the difference in the support amounts of catalyst particles on the surfaces of the PTFE fibers depends upon the amount of catalyst powder particles mixed.

It was confirmed that the sizes of the catalyst particles observed with a scanning electron microscope were mostly 1.0 μm or less, and the particles were distributed relatively uniformly. Although particles larger than 2 μm were observed partially, they were not distributed to a level that could be representative.

It was observed that the catalyst was distributed in large quantities in the longitudinal grooves of the PTFE fibers. It is believed that this is because grooves are formed in areas containing a large amount of catalyst particles during the stretching process.

When a fiber is manufactured by mixing PTFE, a polymer material, and a solid inorganic catalyst, most of the catalyst exists inside the polymer fiber, reaction gases are adsorbed onto only a portion exposed to the outer surface of the fiber and this portion is used as a catalytic activity point. Therefore, there is a concern that the utilization of the catalyst will decrease.

However, grooves are formed in a catalyst-mixed area as the PTFE material mixed with the catalyst is compressed and stretched, so that the catalyst exposure increases, thereby increasing the catalyst utilization.

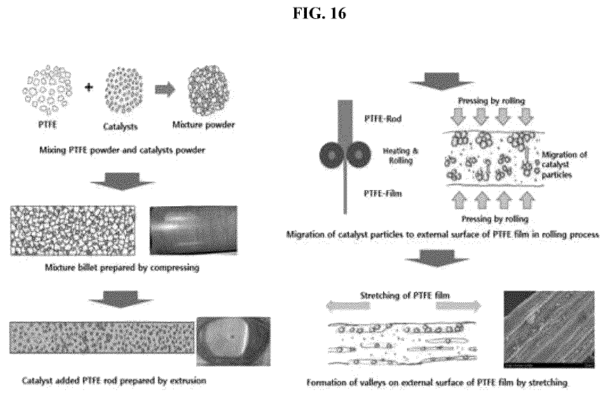

FIG. 16 is a conceptual diagram explaining the surface modification mechanism in a manufacturing process of PTFE catalyst filter fibers.

Referring to FIG. 16, PTFE fibers are manufactured by physically mixing PTFE powder and the catalyst powder, and then going through (1) a billet manufacturing process of compressing a powder mixed with PTFE-catalyst, (2) a PTFE rod manufacturing process in which the catalyst is dispersed by hot extrusion, (3) a PTFE film manufacturing process by hot rolling, (4) a PTFE film stretching process, and (5) a PTFE fiber manufacturing process of slitting the stretched thin PTFE film.

The physically mixed PTFE and catalyst powder are compressed into a cylinder-shaped compressed product with a diameter of 100 mm and a length of 300 mm, and the density of the two mixed powders is relatively low. In a heating extrusion step, a long PTFE rod with a diameter of about 10 mm, which has high density and is flexible, is extruded.

Inside the PTFE rod, the catalyst exists in a highly dispersed state.

The PTFE rod passes again between two heated rolls during a rolling process, thereby being manufactured into a PTFE film.

At this time, pressure is applied in the vertical direction of the rod, and catalyst particles existing inside the PTFE rod are pushed out to the surface at a step of being manufactured into a thin film by applying vertical pressure.

The surface morphology of PTFE fibers which are manufactured in the same manner but do not contain a catalyst is confirmed to be free of grooves. That is, it is considered that the groove is formed at the part where the catalyst is located when the PTFE film is stretched in the longitudinal direction during the stretching process.

### Cross-Section EDX Analysis of PTFE Catalyst Filter Fiber

To confirm the distribution of catalyst particles on the cross-sections of PTFE fibers manufactured by adding catalyst, the cross-sections of the fibers were cut and observed using the EDX mapping technique.

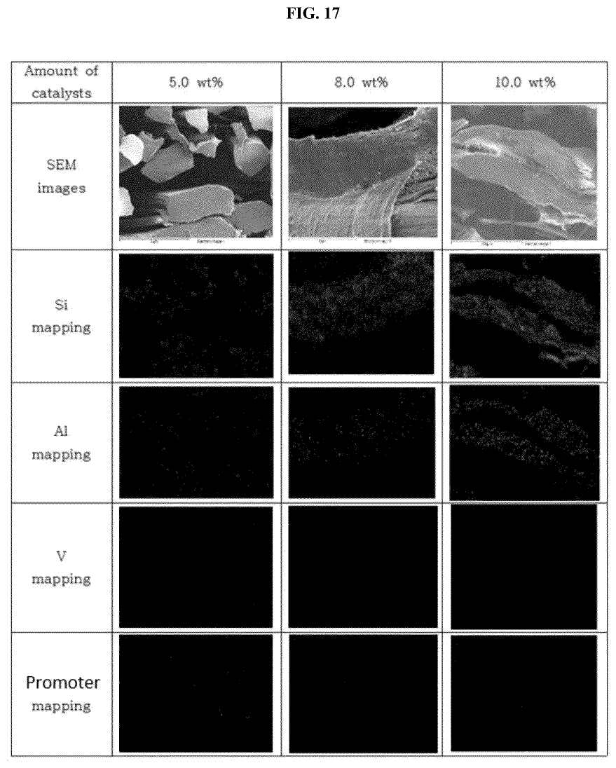

FIG. 17 illustrates the cross-sectional views of PTFE catalyst filter fibers having different catalyst contents, observed by the EDX mapping technique.

From FIG. 17, it can be confirmed that the catalyst content inside the fibers increases as the addition amount of the catalyst increases. As shown in the EDX mapping, the distribution of Si and Al among the elements contained in the catalyst can be confirmed. Referring to the drawing, it is considered appropriate to observe the dispersion of the catalyst inside PTFE with the mapping image of Si that has the highest content.

As a result of the observation, the relatively large catalyst particles on the surface of PTFE fibers observed by SEM were not observed in the cross-section, and it was confirmed that more catalyst particles were distributed on the surface of the fiber than on the cross-section thereof.

### Catalytic Activity Evaluation of Catalyst-Added PTFE Fibers

The PTFE fibers manufactured while changing the addition amount of the V₂O₅ (2.5)-promoter (7.5)/zeolite catalyst to 5 wt %, 8 wt % and 10 wt % were charged into a tubular reactor to perform a denitrification experiment.

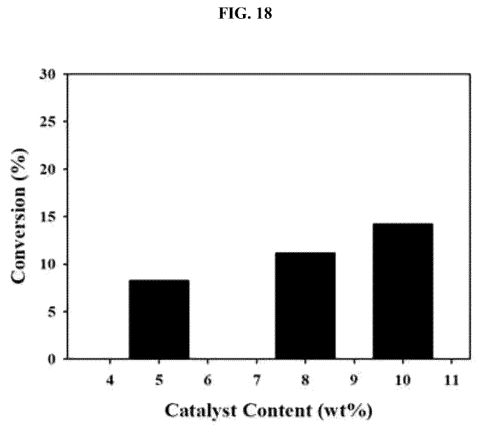

FIG. 18 illustrates a set of graphs for comparing the activity of PTFE fibers dependent upon the addition amount of a catalyst in an NH₃-SCR reaction.

The conditions for the catalyst activity comparison experiment are as follows.

6.0 g of PTFE fiber with added catalyst was charged, and simulated exhaust gases containing 170 ppmv NOx were supplied to the reactor at 1.5 L/min, and the reaction temperature was maintained at 200° C.

As a result of the experiment, the conversion rates of NO were confirmed to be 8, 13, and 15% for PTFE fibers with 5, 8, and 10 wt % catalysts, respectively. According, it can be confirmed that the NO conversion rate also increases as the content of the catalyst increases.

When the NO conversion rate of the V₂O₅/TiO₂ catalyst manufactured by the same method was confirmed as a comparative group, the NO conversion rate of the PTFE catalyst filter manufactured with the V₂O₅/TiO₂ catalyst was confirmed to be less than 5%. Accordingly, it can be confirmed that the catalyst filter manufactured by adding the zeolite-based support exhibits greatly improved performances, compared to conventional V₂O₅/TiO₂ catalyst-based PTFE catalyst filters.

Analysis of Solid Content in PTFE Fibers with Catalyst Added

The actual catalyst contents in PTFE catalyst fibers manufactured by adding the catalyst were measured using a thermogravimetric analyzer (TGA).

The catalyst content TGA analysis was performed by oxidizing PTFE catalyst fiber samples from room temperature to 900° C. at a heating rate of 5° C./min in an air atmosphere and observing the weight change.

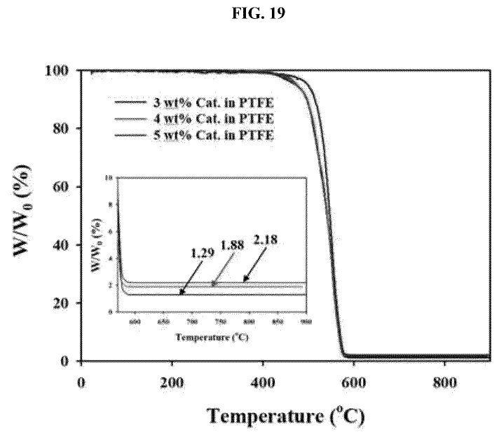

FIG. 19 illustrates a graph comparing the actual catalyst contents of PTFE fibers by TG analysis.

Referring to FIG. 19, all three samples showed weight loss at 400° C. and were completely oxidized at 580° C.

The difference in the residual amount after complete oxidation was confirmed according to the amount of the catalyst added to PTFE, and when 5, 8, and 10 wt % of the catalyst were added, the residual amount after oxidation was 1.29%, 1.88%, and 2.18%, respectively. It is considered that a significant amount of the catalyst is lost in the slitting process during the PTFE fiber manufacturing process.

### Performance Comparison of PTFE Catalyst Fiber and Powder Catalyst Based on Actual Catalyst Amounts Contained

Based on the TGA results, the NO removal performance of the PTFE fiber was compared with the powder catalyst corresponding to the amount of the catalyst contained in the PTFE catalyst fiber.

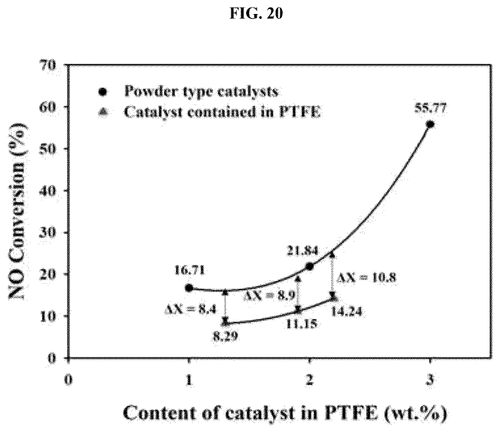

FIG. 20 illustrates a set of graphs comparing the NO conversion rates of a powder catalyst and a PTFE catalyst fiber in an NH₃-SCR reaction.

Referring to FIG. 20, when the powder catalyst corresponding to the case where 1 wt % of the catalyst was contained in the PTFE fiber was charged, the NO conversion rate was about 15%, and when the powder catalyst corresponding to the case where 2 wt % of catalyst was contained, the NO conversion rate was about 22%.

The PTFE fibers with the actual V₂O₅ (2.5)-promoter (7.5)/zeolite catalyst addition amounts of 5, 8, and 10 wt % were confirmed to contain about 1.3, 1.9, and 2.2 wt % of the catalyst as a result of TGA analysis, and the respective NO conversion rates were confirmed to be about 8.3, 11.2, and 14.2%.

From the drawing, it can be confirmed that the NO conversion rates of the powder catalyst and the catalyst contained in the PTFE fiber have a difference of about 8.4 to 10.8% based on the same catalyst amount.

In addition, it can be confirmed from the graphs that, when the amount of the catalyst contained in the PTFE fiber is between 1.3 wt % and 1.9 wt %, the NO conversion rate difference between the powder catalyst and the catalyst is minimal.

When examined qualitatively, the conversion rate graph of the powder-type catalyst is close to a second-order curve and forms a minimum point when the x-axis (content of catalyst in PTFE) value is around 1.2 to 1.4 wt %. The conversion rate graph of the catalyst contained in the PTFE fiber is close to a second-order curve with a relatively small slope, and becomes smaller as the x-axis (content of catalyst in PTFE) value decreases. Accordingly, it can be seen that the closest point of the two graphs exists between the x-axis (content of catalyst in PTFE) values of 1.3 wt % and 1.9 wt %.

In quantitative terms, the second-order approximation of the graph of “powder type catalysts” is ‘y=14.658x2−39.71x+42.636’, and the second-order approximation of “catalyst contained in PTFE graph” is ‘y=0.0471x2+1.1971x+7.046’. When calculating the closest point of the two graphs, the Δy value becomes about 7.061 when x is about 1.317.

From the TGA analysis results, it can be seen that, when the addition amount of the catalyst in the powder for manufacturing PTFE fibers is 5 wt %, the catalyst content of the fiber becomes 1.29 wt %, and, when the catalyst addition amount in the powder is 8 wt %, the catalyst content of the fiber becomes 1.88 wt %. In addition, it can be confirmed that the critical value (x=1.317 wt %) is included within this range.

### <Performance Comparison of PTFE Catalyst Filters According to Lamination Conditions>

According to one embodiment of the present invention, a PTFE membrane catalyst filter is produced by manufacturing a nonwoven fabric using PTFE fibers manufactured by the method described above and then going through a lamination process.

A sample of a PTFE membrane catalyst filter produced in a sample analyzer was placed, and the NOx values at the front and rear ends of the sample analyzer were measured, and then the DeNOx efficiency was calculated using the Mathematical Formula 3 below.

$$DeNOx ( \% ) = \frac{\begin{matrix}NO x ( \% ) at front end - \\ NO x ( \% ) after {NH}_{3} injection\end{matrix}}{NO x ( \% ) at front end} \times 100 \qquad [ Mathematical Formula 3 ]$$

In this experiment, the DeNOx efficiency of PTFE catalyst filters produced under different temperature conditions during cross-sectional lamination was confirmed.

TABLE 2

| Lamination | | |
|---|---|---|
| temperature | Reaction temperature | DeNOx efficiency |
| 310° C. | 160 | 50.2 |
| | 180 | 52.5 |
| | 200 | 58.1 |
| 350° C. | 160 | 61.6 |
| | 180 | 63.6 |
| | 200 | 69.4 |
| 390° C. | 160 | 63.0 |
| | 180 | 67.2 |
| | 200 | 70.3 |

In addition, Table 3 below shows whether the PTFE membrane filter commercialization criteria (air permeability, filtration efficiency, and differential pressure) are met according to lamination temperature conditions.

TABLE 3

| | Lamination | Lamination | Lamination |
|---|---|---|---|
| | (310° C./3 kg) | (350° C./3 kg) | (390° C./3 kg) |
| DeNOx efficiency | X | ◯ | ◯ |
| (60% or more) | | | |
| Air permeability | X | ◯ | X |
| (125 pa: 1.5 or more) | | | |
| Filtration efficiency | X | ◯ | X |
| (99.9% or more) | | | |
| Differential pressure | X | ◯ | X |
| (70 mmAq or less) | | | |

As a result of the experiment, it was confirmed that, when the lamination temperature was set to 350° C., not only the DeNOx efficiency but also the PTFE membrane filter commercialization conditions (air permeability, filtration efficiency, and differential pressure) were met.

According to at least one embodiment of the present invention described above, a more efficient denitrification catalyst can be manufactured by adjusting the components constituting the denitrification catalyst and a ratio between the respective components, it is possible to produce a catalyst powder for manufacturing PTFE fibers with less efficiency reduction compared to the denitrification efficacy of the catalyst powder itself by optimizing the ratio of

PTFE powder and catalyst powder, the surface of the PTFE fibers can be modified by applying mixed denitrification catalyst solid particles to impart the denitrification performance to the PTFE fibers, and, by using this, it is possible to produce a PTFE catalyst filter in which the catalyst is uniformly added to the PTFE fibers. In addition, according to one embodiment of the present invention, the DeNOx efficiency of the catalyst filter can be improved by reducing the desorption of catalyst particles in a lamination process. Further, when coating the denitrification catalyst on the PTFE nonwoven fabric according to another embodiment, improved effects, such as increased filter productivity and increased filter efficiency due to the application of an improved drying method, compared to the prior art, can be expected.

The embodiments described in this specification and the accompanying drawings are merely illustrative of some of the technical ideas included in the present invention. Therefore, since the embodiments disclosed in this specification are not intended to limit the technical idea of the present invention but to explain it, it is obvious that the scope of the technical idea of the present invention is not limited by these embodiments. All modifications and specific embodiments that can be easily inferred by a person skilled in the art within the scope of the technical idea included in the specification and drawings of the present invention should be interpreted as being included within the scope of the rights of the present invention.

What is claimed is:

1. A method for modifying a surface of PTFE fiber by mixing with solid particles, the method comprising:
mixing PTFE powder and De-NOx catalyst in a mixer and compressing it to produce a PTFE billet;
extruding the produced PTFE billet to generate a PTFE rod;
rolling the PTFE rod using a heated roller to produce a PTFE film; and
stretching the PTFE film in a longitudinal direction, and then producing PTFE fibers through a slitting process,
wherein catalyst particles present inside the PTFE film are exposed to a fiber surface through the stretching and the slitting process.

2. The method according to claim 1, wherein the De-NOx catalyst is manufactured by supporting greater than 0 wt % and less than 5 wt % of V₂O₅ and greater than 5 wt % and less than 10 wt % of a promoter on 85 wt % or more and less than 95 wt % of a zeolite support based on a total weight of the catalyst.

3. The method according to claim 2, wherein the De-NOx catalyst is added in an amount of 5 wt % to 8 wt % based on a total weight of the powder.

4. The method according to claim 3, wherein the promoter is selected from the group consisting of copper (Cu), manganese (Mn), tungsten (W), boron (B), aluminum (Al), bismuth (Bi), silicon (Si), tin (Sn), lead (Pb), antimony (Sb), chromium (Cr), iron (Fe), cobalt (Co), nickel (Ni), zinc (Zn), gallium (Ga), cerium (Ce), yttrium (Y), niobium (Nb) and molybdenum (Mo).

5. The method according to claim 4, wherein the supported zeolite is manufactured in a powder form by drying at a temperature of 140° C. or higher and lower than 160° C. for 10 hours to 13 hours and heat-treating in a muffle furnace at a temperature of 350° C. or higher and lower than 450° C. for a time of 3 hours or more and less than 5 hours, and then ground by a ball mill.

6. A method of manufacturing PTFE fibers, the method comprising:
mixing a De-NOx catalyst, manufactured by using PTFE powder and zeolite as a support and using vanadium and a promoter adjusted at a predetermined ratio, in a mixer and compressing it to produce a PTFE billet;
extruding the produced PTFE billet to generate a PTFE rod;
rolling the PTFE rod using a heated roller to produce a PTFE film; and
stretching the PTFE film in a longitudinal direction, and then manufacturing it in a fiber shape through a slitting process.

7. The method according to claim 6, wherein the De-NOx catalyst is manufactured by supporting greater than 0 wt % and less than 5 wt % of V₂O₅ and greater than 5 wt % and less than 10 wt % of a promoter on 85 wt % or more and less than 95 wt % of a zeolite support based on a total weight of the catalyst.

8. The method according to claim 7, wherein the De-NOx catalyst is added in an amount of 5 wt % to 8 wt % based on a total weight of the powder.

9. The method according to claim 8, wherein the promoter is selected from the group consisting of copper (Cu), manganese (Mn), tungsten (W), boron (B), aluminum (Al), bismuth (Bi), silicon (Si), tin (Sn), lead (Pb), antimony (Sb), chromium (Cr), iron (Fe), cobalt (Co), nickel (Ni), zinc (Zn), gallium (Ga), cerium (Ce), yttrium (Y), niobium (Nb) and molybdenum (Mo).

10. The method according to claim 9, wherein the supported zeolite is manufactured in a powder form by drying at a temperature of 140° C. or higher and lower than 160° C. for 10 hours to 13 hours and heat-treating in a muffle furnace at a temperature of 350° C. or higher and lower than 450° C. for a time of 3 hours or more and less than 5 hours, and then ground by a ball mill.
